(19) United States
(12) Patent Application Publication
(10) Pub. No.: US 2008/0235190 A1
(43) Pub. Date: Sep. 25, 2008

(54) Method and System For Intelligently Retrieving and Refining Information

(76) Inventor: Kaihao Zhao, Beijing (CN)

Correspondence Address: Zhen Zheng Lu, 636 S. Cochran Ave. #103, Los Angeles, CA, 90036, US

(21) Appl. No.: 11/918,551

(22) PCT Filed: May 22, 2007
(86) PCT No.: PCT/CN2007/001662

§ 371 Date: Oct. 14, 2007

(30) Foreign Application Priority Data
May 22, 2006 (CN) 200610081367.6

(51) Int. Cl. G06F 7/06; G06F 17/30

(52) U.S. Cl. 707/3; 707/100; 707/E17.014

(57) ABSTRACT

A system and method for intelligently retrieving and refining information, wherein the system includes an intelligent data refining sub-system, a refining database, a releasing and management module, a retrieving database, and intelligent retrieving sub-system. The releasing and management module comprises a releasing and synchronization module, and a data open and management module, wherein the data is classified into twelve categories and refined by the system. The method of the present invention includes the steps of: inputting query terms, pre-processing, fractionizing the retrieving requirements into simple and direct retrieval, advanced and combined retrieval, classification browser retrieval, full text retrieval, and intelligent logic retrieval, wherein the former three kinds of retrievals will be directly performed by the relation retrieving engine, the full text retrieval will be directly performed by the full text retrieving engine, and the intelligent logic retrieval will be achieved by the relation retrieving engine after the query terms re-organized. Finally, return to the retrieved results.

### BACKGROUND OF THE PRESENT INVENTION

1. Field of Invention

The present invention generally relates to a kind of method and system for intelligently retrieving and refining information, and more particularly, relates to a method and system for intelligently retrieving and refining information from text, image, video and audios.

2. Description of Related Arts

As known to everyone, database is widely applied to all kinds of electronic data, literature, business data resource, and network search. Such that, for the application field of database, it is very important to effectively retrieve and refine data information and documents.

Recently, the retrieving techniques for data information in this field generally perform a search by using the Boolean expression as a query term which is based on the statistical keywords. For documents database, there is a dictionary storing a lot of keywords and each of the keywords are concretely positioned in the related documents. Depending on such a dictionary, through comparing the keywords of query terms with the one of basic documents, the corresponding documents will be retrieved. In addition, in order to improve the retrieving techniques, a fuzzy logic module, a vector space module, and a probabilistic retrieval module are adopted for retrieving documents and data information.

However, the existing retrieving method only can performs a search based on comparing the keywords of query terms with the one of basic documents. Although the basic documents are in relation to the keywords of the query terms, if the keywords cannot be retrieved from the basic documents, there will be no retrieving results show up. Therefore, we need do our best to improve the retrieving techniques to realize the retrieval depending on a comparability degree between the keywords of query terms and basic documents, such that the retrieved results will have more association with the keywords of query terms. For example, depending on the existing retrieval techniques, we may retrieve the documents comprising the same keywords with the query terms, but actually the retrieved basic documents has no relation to the query terms; On the contrary, if there are no same keywords included in the basic documents with respect to query terms, the associated basic documents will not be retrieved under the existing retrieval techniques. For the data included in the basic documents, the existing retrieval method can not distinctively identify it, or refine and make use of the retrieved information based on the property relation of information. Of course, it is impossible for the existing method to realize inter-analysis and intercomparsion among different documents, and to refine and make use of information content time after time among different documents.

Recently, for all kinds of database, the information refining and retrieving results are processed from one document to another, that is, if there will no corresponding keywords match the keywords of query terms, the retrieving method will change its target to another document without doing information refining or relation analysis on one documents. However, the information property is very rich included in one document, but the existing retrieving method only aims at one point, which leads to many problems produced during information refining and results retrieving.

Presently, when doing an information retrieval, the retrieval always is performed by appointing a subject, marking specific keywords, and determining a type of document abstract to identify the property of the original documents, then using the identified property to work as a retrieval keyword during the retrieving process. However, there is a pressing problem with this conventional information retrieval method. The identified property can not completely embody all the information data of the documents. For example, although the content of original documents are related to the query terms, there is no keywords of original documents corresponding to the one of query terms, finally there will be no documents to satisfy the query term, and the user will retrieve nothing.

For retrieved results from database, because there is rich information contained in one document, a great deal of information which has no relation with the query terms will make the retrieved result redundant. Finally, a lot of retrieved documents having no relation to the query terms will be retrieved out, which decreases the efficiency of retrieving method.

### SUMMARY OF THE PRESENT INVENTION

A main object of the present invention is to provide a method and system for intelligently retrieving and refining information, wherein all kinds of data and document retrieval can be realized by the method and system. The present invention even can satisfy the intelligent refining requirements of data information, such as, the information comparison and analysis among different keywords which are included in the same document or existing in different documents can be realized in the system, and new relation among different keywords can be configured by the present invention. Therefore, although there are no corresponding keywords between a query term and a basic document, one still can retrieve the data which actually has relation with the keyword and connotatively existing in the database. At the same time, depending on the position expression technology of various formats existing in the system, the content of many kinds of medium formats can be retrieved and refined, such as text, image, audio and video.

Another main object of the present invention is to configurate a retrieving method and indexing system for many medium formats which are based on completely division, index text content, and the configuration of advanced, flexible and intelligent index system. A flexible and efficient networking index system is configurated through designing and achieving the relation tri-gram, and describing the relation among Chinese characters from different perspective. Depending on the networking index system, an intelligent and semantic retrieving technology is achieved. At the same time, depending on the standardization of content index method, the association and comparison among words and contents are more intelligent. Therefore, one can retrieve the data which actually has relation with the keywords and connotatively existing in the database.

Another object of the present invention is to provide a method and system for intelligently retrieving and refining information, depending on such method and system, the retrieved results can be refined so as to maximumly decrease the retrieved results having no relation with the query terms, such that the retrieved results can match with the retrieving requirements to the maximum extent.

Another object of the present invention is to provide a method and system which can satisfy random retrieving requirements during intelligently retrieving and refining information.

Another object of the present invention is to provide a method and system which can provide retrieved results based on a real relation among query terms and basic database, but not based on a comparison between the keywords of query terms with the one of basic database, which can be realized through the rich information background and exact information release paths of the system.

Another object of the present invention is to provide a method and system which can realize the integration of new information content and knowledge among any information sources based on the lever of knowledge unit. And can realize the networking comparison among universal properties of any information contents which are based on character, event, time, place; article, production, life, and activity. Moreover, the present invention can realize a second refining for many kinds of medium formats which include text, image, audio and video, such that a secondary literature, tertiary literature, or multi-literature can be automatically produced.

Another object of the present invention is to provide a method and system which can realize the activation and refining for the great deal of basic information, so as to quickly and orderly transform the information into knowledge.

Another object of the present invention is to provide a method and system which can provide a best retrieval path for retrieving and refining information in compliance with the query terms, and there is rich knowledge contained in the system coming from different ways, such as the knowledge from production, life, and activities. Therefore, the system and method of the present invention can provide a comprehensive retrieval.

Another object of the present invention is to provide a method and system for intelligently retrieving and refining information, wherein the system perfectly matches with the human subjective requirements of knowledge, and the method is universal and can be applied to many formats. One can retrieve information from different ways and perform the retrieval without training. It is very convenient to retrieve and remember the information by using the present invention.

Accordingly, in order to accomplish the above objects, the present invention provides a system for intelligently retrieving and refining, comprising:

an intelligent data refining sub-system;

a refining database, wherein the data refining sub-system is used to refine a text, image, audio and video data into knowledge units and index information which are completely and correctly divided and indexed, wherein the knowledge units and index information are stored in the refining database, and there are still a great deal of index information and bridging information for accelerating refining stored in the refining database;

a retrieving database;

an intelligent retrieval service sub-system providing a service platform for intelligent retrieval, wherein the retrieval service sub-system jointly processes all the retrieving requirements, and performs corresponding retrieval from the retrieving database to intelligently retrieve the related content; and

a releasing and management module including a data releasing and synchronization module, and a data open and management module, wherein the releasing and management module makes the approved content and index information synchronous to the data displayed in the retrieval service sub-system, wherein the data synchronization is realized by the data releasing and synchronization module which synchronously transmits the contents from the refining database to the retrieving database, and the feedback information produced during retrieval will be synchronously transmitted from the retrieving database to the refining database, wherein the access authority is configurated by the data open and management module

The present invention also provides a method for intelligently retrieving and refining information, comprising the steps of:

(a) inputting a query term, wherein excepting the keywords input and index browser adopted in many existing retrieving system can be performed in the present invention, a lot of special Chinese characters which included or not included in the Unicode database also can be inputted as a query term through etymon, strokes methods;

(b) pre-processing the query terms, wherein the pre-processing comprises code-switching and index complexity evaluation;

(c) fractionizing the retrieving requirements into simple direct retrieval, advanced combined retrieval, classification browser retrieval, full text retrieval, and intelligent logic retrieval, wherein the former three kinds of retrievals will be directly performed by the relation retrieving engine, the full text retrieval will be directly performed by the full text retrieving engine, and the intelligent logic retrieval will be achieved by the relation retrieving engine after the query terms re-organized based on the logical relation deduction;

(d) returning to retrieved results when the retrieved results are obtained by the relation retrieving engine and the full text retrieving engine.

In the step (a), the relation keywords Kr comprise subjection relation, equivalent relation with different names, and relation of background reference.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a typical tri-gram according to the present invention.

FIG. 2 illustrates the relation between keywords for retrieving person according to a preferred embodiment of the present invention.

FIG. 3 illustrates the relation of relation keyword Kr to another relation keyword according to the above preferred embodiment of the present invention.

FIG. 4 is a deducting schematic view of the inverted relation according to the above preferred embodiment of the present invention.

FIG. 5 is a deducting schematic view of the secondary relation according to the above preferred embodiment of the present invention.

FIG. 6 is a deducting schematic view of the relation of same subject according to the above preferred embodiment of the present invention.

FIG. 7 is a deducting schematic view of the symmetrical relation according to the above preferred embodiment of the present invention.

FIG. 8 is a schematic view of the system according to the present invention.

FIG. 9 is a flow chart of the method according to the present invention.

### DETAILED DESCRIPTION OF THE PREFERRED EMBODIMENT

The present invention is to configurate a retrieving and refining system based on dividing the real meaning and structure of the retrieved or refined information. Therefore, the performance of the present invention will not be limited by comparing the words expression of query terms with those of basic texts, such that the retrieved information can be mostly associated with the query terms. Even the basic information comprises a same keyword with the query term, if the information has no association with the query term, the information will not be retrieved. On the other hand, the present invention provides comprehensive information for retrieving requirements, although the words expression of basic information are not the same with the query terms, the information associated with the query terms also can be retrieved.

Moreover, an advanced and flexible intelligent index system is configurated by the present invention. Based on the system, it can make sure that all kinds of basic information are scientific and logical. On the other hand, the basic information falls into various categories according to users' habits, such that it is convenient for users to retrieve information based on the system of the present invention.

The existing retrieving engines and service systems will not be rejected by the present invention. On the contrary, the present invention can be perfectly integrated with the existing retrieving engines and service systems to perform corresponding function according to the retrieving requirements, such that a more powerful retrieving system will be implemented.

To provide exact retrieved results in compliance with the query terms is realized by dividing the retrieving results which display in the form of knowledge. The division comprises two levels, one is to divide the retrieving results into several independent and complete “knowledge units” or “knowledge paced”; the other level is to extract all keywords included in the basic information to enrich the associated information of the keywords, and outstand a keywords having the same meaning with a query term but having different words expression. Therefore, the knowledge property is enriched by the present invention. The keywords have no association with the query term will be excluded, depending on which, the interruption of sub-information with respect to a query term will be greatly decreased in the database.

The existing classification browser and keywords match are integrated in the intelligent retrieving system of the present invention. Different from the existing retrieving engines, the classification Brower of the present invention not only can be fractionized according to the relation of member subjection, such as classification of subjects, custom, but also provides two lateral developing retrieving paths based on the equivalent relation with different names and the relation of background reference. Different from the related link jump included in the existing systems, the lateral retrieving paths have specific targets based on the classification Brower. Moreover, according to keywords match between database and query terms, the keywords having same word expression with the one of the query term will be retrieved from the database, while the retrieved keywords maybe has different meaning with the retrieving requirements. However, users can clearly understand the related information of the retrieved keywords through the system instruction, then directly and quickly pursue a second retrieval to locate the results.

The simplest unit of natural semantem is the division standard of the knowledge units, such that the property of each knowledge units can be completely displayed, which make sure the retrieved results maximumly math the query terms to decrease the information having no association with the retrieving requirements.

The intelligent retrieving and refining system of the present invention is completely configurated based on the instinct requirements and thought logic of human being. According to the thought ways of human being used to retrieve and make use of knowledge, the database of the present invention are classified into twelve categories, that is character, event, time, place, articles, creature, clothes, food, house, transportation thing, sports thing, entertainment thing. Each of the twelve categories can be fractionized into a number of sub-categories, such as, the sub-categories of character comprise name, sex, birth place and so on. Moreover, each of sub-categories can be fractionized into a number of secondary sub-categories, such as, name of character can be classified into Zhao, Zhang, Li and so on. The level structure of the present invention is just like the structure of a tree, and an index structure comprises 30 levels can substantially express all kinds of fractionized data. The index categories and their sub-categories are coded, based on which, a second information refining will be performed. After totally extracting the background reference of the index structure, the extracted information will be indexed, reordered and re-categorized. Therefore, an advanced and flexible intelligent index system will be achieved.

All kinds of information data comprising different kinds of literatures, electronic data will be divided into a number of knowledge units according to the content length or file size of the information data, wherein the characters included in each knowledge unit are within 600, and each of the knowledge units are coded with corresponding code. Then each knowledge units will be analyzed and divided by the system, and all the keywords included in the knowledge units will be extracted and categorized according to the above classification method. Moreover, the keywords will be coded and located to the corresponding sub-categories of the relation tree.

The classification method of the present invention is essentially different from the conventional classification logic, and completely breaks the conventional classification concept. Presently, the other classification methods are mainly based on the structural levels in compliance with the related specialty, not dedicated to satisfy the natural knowledge requirements of different human being. Therefore, the existing classification method is limited by their classification concept.

What is worth mentioning is that the existing classification methods based on specialty also integrated in the present invention, and the classification method of the present invention aims to satisfy the natural knowledge requirements of human beings. Therefore, the present invention can cover and include all kinds of other classification methods based on its universal classification perspectives, such that all kinds of classification methods can be integrated in the present invention so as to create technical support for knowledge processing and usage integration.

In order to configure a flexible and intelligent index system, a kind of self-contained and self-organizing tri-gram is configured in the present invention. As known to everyone, all the normal languages comprise main grammatical structure which includes subject, predicate and object. This kind of grammatical structure is simulated in the present invention. Based on the tri-gram, the data expression, store, and retrieval are realized in the present invention.

Referring to FIG. 1 the drawings, a tri-gram according to the present invention is illustrated. The tri-gram comprises an organization of Ka, Kr and Kr, wherein Ka stands for keyword a, Kb stands for keyword b, and Kr named relation keyword stands for the relation between the keywords a and b, such that three kinds of associated relation between the keywords a and b represented and realized by the tri-gram. The relation keyword Kr comprises subjection relation, equivalent relation with different names, and relation of background reference.

Moreover, each of the three associated relation between the keywords a and b can be continuously fractionized, and two of the three associated relationship still can realize the three associated relationship again. Depending on such deducting pattern of the tri-gram, a logical retrieval can be realized by the method of the present invention, which is very different from the existing retrieving method performing a search by comparing keywords.

Referring to FIG. 1 again, Krᵣ represents a kind of relation to make Kr has logical relation with another relation keyword, such as inverse relation, secondary relation, same subject, and symmetrical relation, wherein depending on Krᵣ, Kr can deduct a new relation called Kr′ which is the new relation of keywords Ka′ to Kb′.

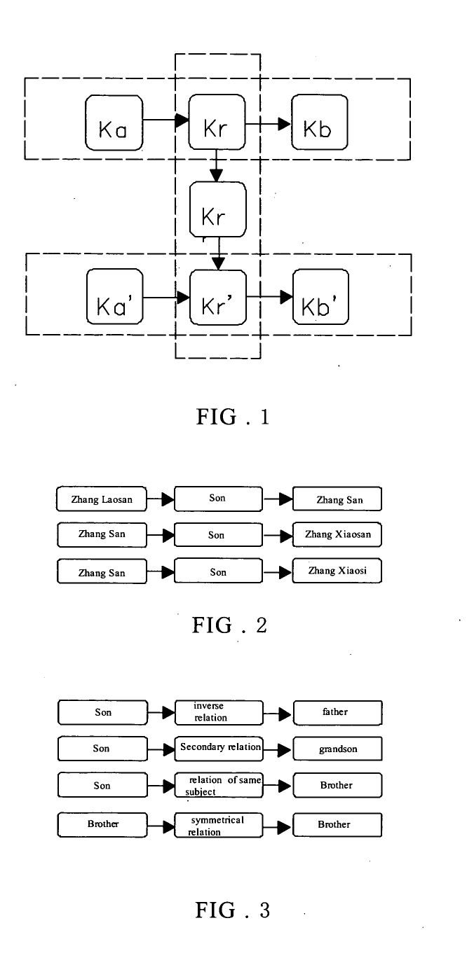

As shown in FIG. 2, it illustrates an embodiment for retrieving person, such as, there are three tri-grams existing in the system of the present invention, they are:

(Zhang Lao San, son, Zhan San) (Zhang San, son, Zhang Xiao San) (Zhang San, son, Zhang Xiao Si).

At the same time, as shown in FIG. 3, based on the relation keyword Kr, three corresponding tri-grams are identified by the system of the present invention, they are:

(son, inverse relation, father); (son, secondary relation, grandson); (son, same subject, brother);

(brother, symmetrical relation, brother).

So the system will automatically deduct retrieving results without increasing any other information.

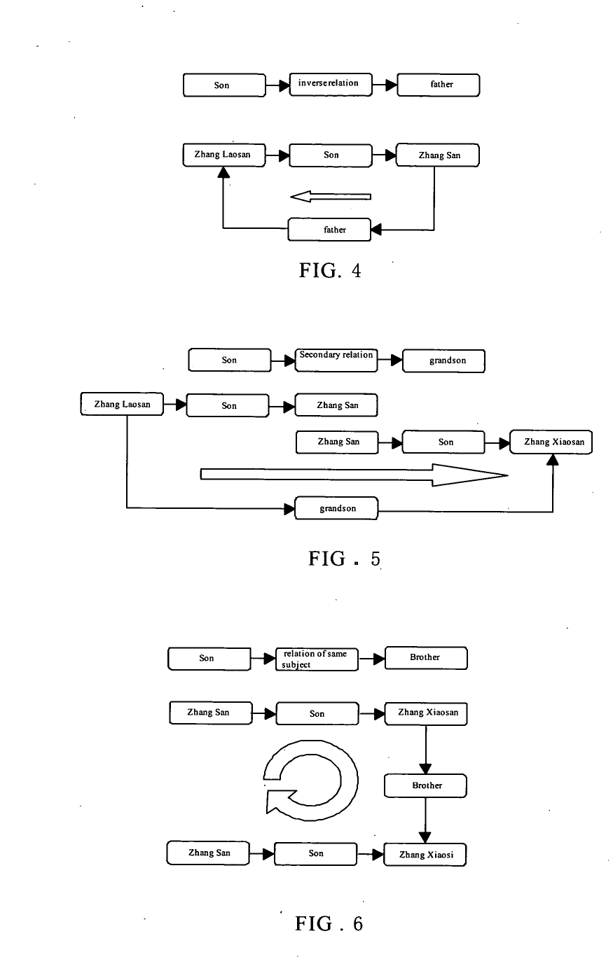

Referring to FIG. 4, based on the inverted relation, the system of the present invention will deduct the follow retrieving results:

(Zhang San, father, Zhang Lao San) (Zhang Xiao San, father, Zhang San)

(Zhang Xiao Si, Father, Zhang San).

Referring to FIG. 5, based on the secondary relation, the system of the present invention will deduct the follow retrieving results:

(Zhang Lao San, grandson, Zhang Xiao San) (Zhang Lao San, grandson, Zhang Xiao Si).

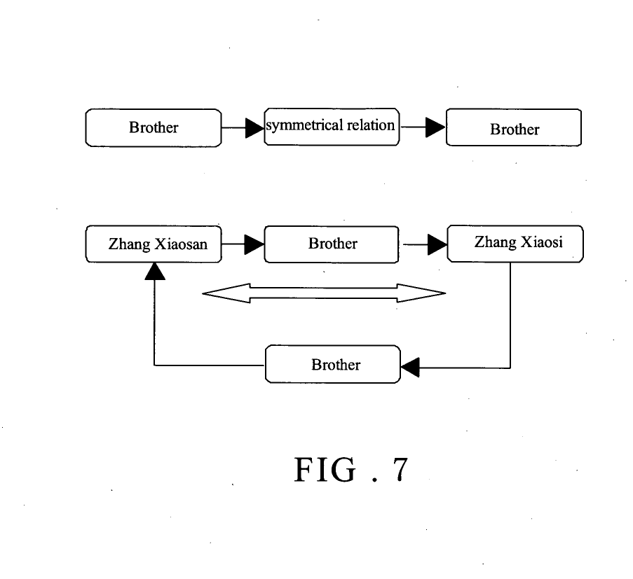

Referring to FIGS. 6 and 7, based on the relation of same subject, the system of the present invention will deduct the follow retrieving results:

(Zhang Xiao San, brother, Zhang Xiao Si), and follow the retrieving result obtained from the relation of same subject, the system will deduct the retrieving result of (Zhang Xiao Si, brother, hang Xiao San).

However, we should know that the deducting sequence will be changed according to the actual situation. All the above logical results can be deducted through the relation tri-gram being applied once. If the relation tri-gram is applied for many times, there will be more logical results deducted for retrieving.

Compared with the existing retrieving system, the above deduction possesses the follow features:

a. the basic data is greatly decreased. As shown in the above example, the basic data only comprises three character tri-grams and four relation tri-grams, while in order to satisfy different retrieval requirements, the existing retrieving system should store comprehensive database, and all the deduced results should be stored in the system to serve as the basic database.

b. the retrieving data is greatly increased. From the deduction of the above example, the retrieving data for users is not only determined by the basic data, but also has relation with the quantity of tri-gram. Generally, a tri-gram is very common, when adding a tri-gram, the retrieving data deducted by the tri-gram will be double increased, or even increased following the geometric series.

c. the retrieved results are more associated with the retrieval requirements. Because most of the retrieving results of the present invention are obtained through logical deduction, the deducted results can be more close to the retrieval requirements. However, for the existing method, all the basic data are independently inputted into the database, so the association among the basic data can not be guaranteed, such as, the results of (Zhang Lao San, Son, Zhang San) and (Zhang San, Brother, Zhang Lao San) maybe be retrieved out at the same time

d. the retrieving results are of expansibility depending on the tri-grams. From the deduction of the above example, we know that all kinds of tri-grams can be defined in the system of this method, as long as the tri-grams are in compliance with logical relation. From this perspective, the relation concluded through life experience and the developmental situation of the existing technology can be realized in this system. On the other hand, as the development of society and technology, there will be new relation keeping produced, and the new relation also can be applied in the system of the present invention. Moreover, depending on the defined new tri-grams, all the data previously inputted will immediately and correspondingly be re-organized for retrieving.

Moreover, the present invention adopts an indexing method, such as tri-gram of keywords. The indexing method is realized and represented through two tri-grams, wherein one tri-gram comprises C, R, K, and the other one includes Ca, R, Cb, wherein C stands for the content of documents, K stands for keywords, and R stands for the relation of documents to the keywords; while Ca stands for the content of a, Cb stands for the content of b, and R stands for the relation of a to b. The position, length, correlation of keywords and the association relation among documents will be stored in the system of this method. Through this kind of indexing, on one side, the retrieved documents can be presented according to the structure of the documents, on the other hand, the retrieved documents can be shown up based on the data source.

What is more, through the tri-gram of C, R, K, The indexing method can perfectly solve the associated relation between the original documents and the retrieval requirements. For example, entering a pronoun of he, through determining the actual associated relation between the keyword “he” and the content of the original documents, the system can provide a retrieved content corresponding with the keyword “he” instead of only providing the content comprising the same keyword with the entering keyword “he”.

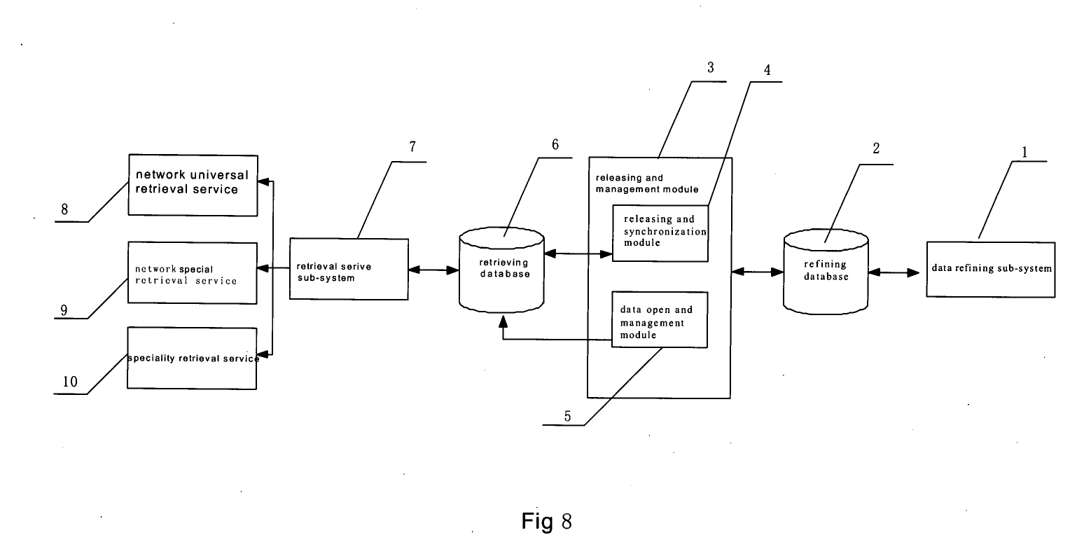

As shown in FIG. 8, it illustrates the whole structure of an intelligent retrieving and refining system of the present invention. The system comprises an intelligent data refining sub-system 1, a refining database 2, a releasing and management module 3, a retrieving database 6, and intelligent retrieval service sub-system 7, wherein the releasing and management module 3 comprises data releasing and synchronization module 4, and data open and management module 5.

The data refining is achieved by intelligent data refining sub-system 1. Depending on the sub-system 1, all data in the form of different mediums will be refined into a kind of text which has been completely divided and indexed, or a kind of content in the form of other medium form, or a flexible and correct index information. During this phase, to operate the refining database 2 is the major thing, wherein excepting the information prepared for final retrieval, there is still a great deal of indexed information and bridging results adapted for accelerating refining stored in the refining database 2.

The data refining comprises the steps of:

(a) refining basic data to make sure all the texts in the database are correct. During this step, the system will proofread all the data inputted in the database, wherein the words, catalogues, paragraph levels, and comments citation of the data will be carefully proofread by the system. Moreover, a number of special Chinese characters included or not included in the Unicode database also can be recognized in the present invention, that is, the inquiry and display of variant characters or pictograph characters will be realized by coding the variant characters or pictograph characters.

(b) intelligently refining knowledge units based on the correct basic data. The system will divide the data consisting of paragraphs into a number of independent and comprehensive “knowledge units”. At the same time, the association relation between the “knowledge units” and the index keywords will be configurated by the system.

(c) intelligent indexing refining, which will be processed at the same time with the step (b), wherein in the step (c), the keywords extracted from the step (b) will be intelligently refined, and the refined results will be through a second refining, such that a flexible and correct, multidimensional direction, network intelligent index will be realized.

(d) re-processing the knowledge units based on the feedback retrieving requirements from the intelligent index, wherein according to users' random requirements to produce a secondary literature, a tertiary literature, or multi-literatures, forms, imagines, audios and videos.

The intelligent data refining sub-system 1 further comprises an operation management and control module which is used to manage the bridging results and data states existing in the above steps. The operation management and control module will not directly affect the data, but will monitor and manage the flow direction of the data.

The releasing and management task will be achieved by the releasing and management module 3. This module 3 mainly makes the approved content and index information synchronous to the data released in the intelligent retrieval service sub-system 7, wherein the data synchronization is reversible. The main data stream flows from the refining database 2 to the retrieving database 6. At the same time, the feedback information produced during retrieval will be synchronous to the refining database 2 from the retrieving database 6, wherein the data synchronization will be realized by the data releasing and synchronous module 4. In addition, setting up the authority of data access is another important task for the releasing and management module 3, which will be functioned by data open and management module 5.

If the retrieving operation is driven by network users, the retrieving requirements will be satisfied by the retrieval service sub-system 7. All the retrieving requirements including lateral universal retrieval and longitudinal special retrieval will be transformed into corresponding internal retrieving requirements to intelligently retrieve the content and index information. The universal requirements are performed by the universal keywords or combined keywords, while the special retrieval requirements will be realized by the classification method of the system. Moreover, during this phase, the system further provides a common access connector for providing service to the special retrieving requirements, such as, another networks can be linked to the system of the present invention to provide service to the special retrieving requirements.

The system further provided a common intelligent retrieving platform used to deal with all kinds of retrieving requirements. Moreover, the system further provides a lateral network universal retrieval service 8 which is used to obtain rich association content, and provides a longitudinal network special retrieval service 9 which is used to obtain high level knowledge. In addition, the common access connector is provided in the form of special retrieval service 10.

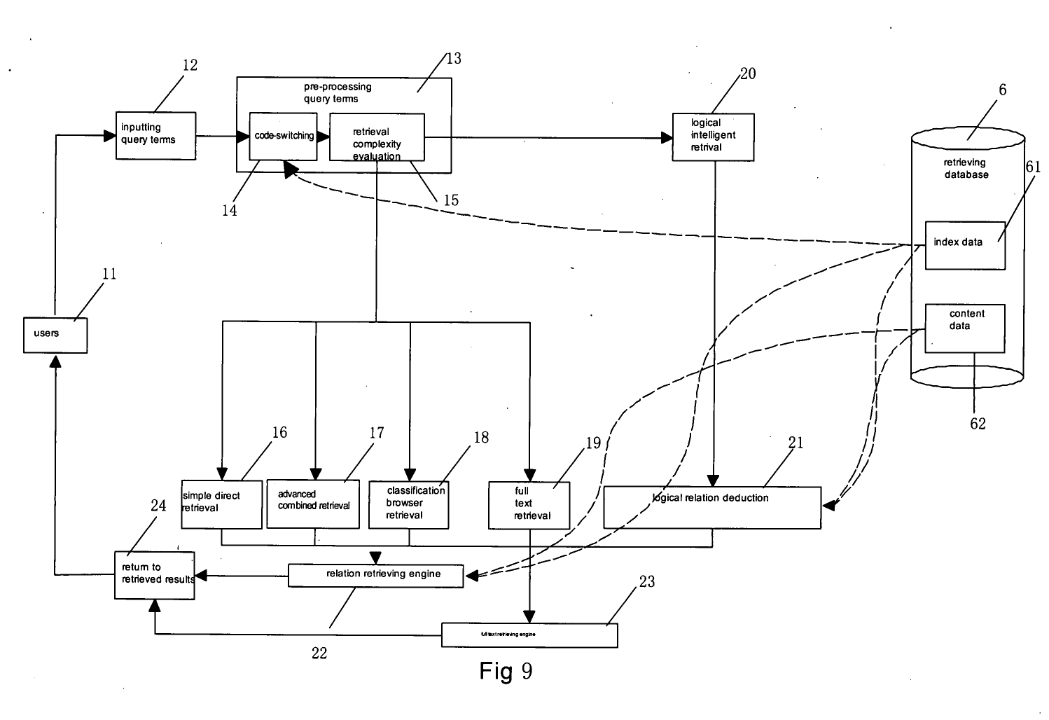

Referring FIG. 9 of the drawings, it illustrates how the present invention deals with the retrieving requirements from user 11, depending on the method for intelligently retrieving and refining information. The panes included in the FIG. 9 stand for all kinds of processing operations, the columns stand for the retrieving database 6 comprising index data 61 and content data 62. The solid line arrows stand for the operation flow, while the dashed stands for the flow direction of the main data.

During actual operation, users 11 enter the query terms 12 through networks provided by the system, or enter query terms 12 through the user interfaces of other systems connected to the system by open connectors. Excepting providing keywords input and index browser, the system further provides spelling input method or Chinese strokes input method to enter a lot of special Chinese characters included or not included in the Unicode database.

After the system obtains the retrieving requirements from users 11, the query terms 12 will be pre-processed 13 by the system, wherein the pre-processing 13 comprises regular code-switching 14 technologies, and index complexity evaluation 15 technologies. After being pre-processed 13, the retrieving requirements will be fractionized into simple direct retrieval 16, advanced combined retrieval 17, classification browser retrieval 18, full text retrieval 19, and intelligent logic retrieval 20. The former three kinds of retrievals will be directly performed by relation retrieving engine 22, the full text retrieval 19 will be directly performed by full text retrieving engine 23, and the intelligent logic retrieval 20 will be achieved by the relation retrieving engine 22 after the query terms 12 re-organized based on logical relation deduction 21. The logical relation deduction 21 is based on the above relation tri-gram, the classification index database, and the method of index knowledge units. After the retrieval results 24 being obtained through the relation retrieving engine 22 and text retrieving engine 23, the system will return to the retrieval results 24 making use of the interface which can substantially embody the internal logical relation between the query terms 12 and retrieval results 24.

The system and method referred in the present invention can be applied to computer stand-alone, local network, enterprise intranet, Internet and so on, the users of this system can be any user who wishes to do information retrieval. The present invention can realize the integration in new information content and knowledge among any information sources based on the lever of knowledge unit, and can realize the intelligent classification, ordering, and clustering among the universal properties of any knowledge source which are based on the human being, event, time, place, article, production, life, and activity.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system for intelligently retrieving and refining information, comprising:
an intelligent data refining sub-system;
a refining database, wherein said data refining sub-system is used to refine a text, image, audio and video data into knowledge units and index information which are completely and correctly divided and indexed, wherein said knowledge units and index information are stored in said refining database, and there are still a great deal of index information and bridging information for accelerating refining stored in said refining database;
a retrieving database;
an intelligent retrieval service sub-system providing a service platform for intelligent retrieval, wherein said retrieval service sub-system jointly processes all the retrieving requirements, and performs corresponding retrieval from said retrieving database to intelligently retrieve the related content; and
a releasing and management module including a data releasing and synchronization module, and a data open and management module, wherein said releasing and management module makes the approved content and index information synchronous to the data displayed in said retrieval service sub-system, wherein said data synchronization is realized by said data releasing and synchronization module which synchronously transmits the contents from said refining database to said retrieving database, and the feedback information produced during retrieval will be synchronously transmitted from said retrieving database to said refining database, wherein the access authority is configurated by said data open and management module

2. The system for intelligently retrieving and refining information, as recited in claim 1, wherein all data will be refined by said intelligent retrieval service sub-system to be classified into twelve categories, wherein said twelve categories comprise character, event, time, place, article, creature, clothes, food, house, transportation thing, sports thing, entertainment thing.

3. The system for intelligently retrieving and refining information, as recited in claim 2, wherein each of said twelve categories is fractionized into a number of sub-categories, and each of said sub-categories is fractionized into a number of secondary sub-categories, wherein the level structure of said twelve categories are formed into the structure of a tree to service as the indexing structure, wherein the nodes of said knowledge units of said tree structure comprise a number of networking subjection relations, and each of said twelve categories and their sub-categories are coded.

4. The system for intelligently retrieving and refining information, as recited in claim 3, wherein the level of said sub-categories is less than 30.

5. The system for intelligently retrieving and refining information, as recited in claim 1, wherein all data is refined by said intelligent data refining sub-system to be divided into a number of knowledge units according to the content length and file size of said data.

6. The system for intelligently retrieving and refining information, as recited in claim 5, wherein the characters included in said text knowledge unit within 600.

7. The system for intelligently retrieving and refining information, as recited in claim 1, wherein said intelligent data refining sub-system adopts a relation tri-gram comprising an organization of Ka, Kr and Kr, wherein the Ka stands for keyword a, the Kb stands for keyword b, and the Kr named relation keyword stands for the relation between the keywords a and b, such that three kinds of associated relation between the keywords a and b is represented and realized by the tri-gram, wherein the relation keyword Kr comprises subjection relation, equivalent relation with different names, and relation of background reference.

8. A method for intelligently retrieving and refining information, comprising the steps:
(a) inputting query terms;
(b) pre-processing said query terms, wherein said pre-processing comprises code-switching and index complexity evaluation;
(c) fractionizing the retrieving requirements into simple direct retrieval, advanced combined retrieval, classification browser retrieval, full text retrieval, and intelligent logic retrieval, wherein said former three kinds of retrievals will be directly performed by the relation retrieving engine, said full text retrieval will be directly performed by the full text retrieving engine, and said intelligent logic retrieval will be achieved by the relation retrieving engine after the query terms re-organized based on the logical relation deduction;
(d) returning to retrieved results when said retrieved results are obtained by the relation retrieving engine and the full text retrieving engine.

9. A method for intelligently refining and processing data, comprising the steps of:
(a) refining basic data to make sure all the texts in the database are correct, wherein the system proofreads all the data inputted in the database, wherein the words, catalogues, paragraph levels, and comments citation of the data are carefully proofread by the system.
(b) intelligently refining knowledge units, wherein the system completely divides the data consisting of paragraphs into a number of independent and comprehensive “knowledge units”, and the association relation between the “knowledge units” and the index keywords is configurated by the system.
(c) intelligently refining index, wherein the index refining is processed at the same time with the step (b), and the keywords extracted from the step (b) are intelligently refined in the step (c), wherein the refined results obtained from the keywords refining will be through a secondary refining to realize a flexible, correct, multidimensional direction, networking intelligent index.
(d) re-processing the knowledge units based on the feedback retrieving requirements from the intelligent index, wherein according to users' random requirements, a new classification, ordering and clustering is realized to produce a secondary literature, a tertiary literature, or multi-literatures, forms, imagines, audios and videos

10. The method for intelligently retrieving and refining information, as recited in claim 8, wherein a number of special Chinese characters included or not included in the standard Unicode database are applied to the system through dividing, ordering, coding the variant characters and pictograph characters, that is, the retrieval and display of said variant characters and pictograph characters are achieved.

11. The method for intelligently retrieving and refining information, as recited in claim 9, wherein a number of special Chinese characters included or not included in the standard Unicode database are applied to the system through dividing, ordering, coding the variant characters and pictograph characters, that is, the retrieval and display of said variant characters and pictograph characters are achieved.
